(19) United States
(12) Patent Application Publication
(10) Pub. No.: US 2013/0279171 A1
(43) Pub. Date: Oct. 24, 2013

(54) REFLECTOR FOR LIGHTING DEVICES COMPRISING MEANS ADAPTED TO ELIMINATE LIGHTING UNEVENNESS

(71) Applicant: iGuzzini Illuminazione S.p. A., Recanati (IT)

(72) Inventor: Massimo Gattari, Potenza Picena (IT)

(21) Appl. No.: 13/845,226

(22) Filed: Mar. 18, 2013

(30) Foreign Application Priority Data
Mar. 19, 2012 (IT) FI2012A0000571

(51) Int. Cl. F21V 7/10; F21V 14/04

(52) U.S. Cl. CPC F21V 7/10; F21V 14/04
USPC 362/282; 362/346; 362/285

(57) ABSTRACT

A reflector for flush installed lighting devices, adapted to eliminate possible undesired spots of light and unevenness of the produced light beam, said reflector being provided with a further reflective element, arranged on the surface of said reflector and essentially parallel to the lying plane of the greater opening of said reflector. Said further reflective element will preferably have a circular segment shape and dimensions which may vary according to the dimensions of said reflector and according to the inclination that the lighting assembly may assume with respect to the main body of the flush installed lighting device.

### FIELD OF THE INVENTION

The present invention relates to the technical field of lighting devices, and in particular to the technical field of reflectors for lighting devices.

### STATE OF THE ART

Light emission uniformity and evenness are factors of primary importance for lighting devices. Reflectors, diffusers and light emission devices are designed and chosen to obtain specific lighting conditions, also in terms of lighting uniformity and evenness.

Referring to lighting uniformity and evenness in terms of illumination means evaluating the distribution differences of the density of radiated lumen. The less even is the emission, the more perceivable are irregularities in light distribution, such as light spots or rings or streaks which interrupt the uniformity of the emitted light field on the illuminated surface.

For instance, emission evenness faults in terms of illumination may be caused by irregularities of the reflecting surface of the reflector or by the particular conformation of the reflector itself or even by the position and orientation of the light source with respect to the reflector.

The latter case is particularly important in the case of lighting devices in which the light source is adjustable or fixed but inclined with respect to the axis of symmetry of the reflector.

The part of the emission of the light source which incides on the surface is reflected according to the local inclination of the reflector portion struck by the incident light rays, in accordance with Euclid's' rules according to which the incidence angle is equal to the reflection angle.

In the case of mutual inclinations between the axis of the beam emitted by the light source and the axis of rotation of the reflector, reflections may occur such as to cause even very significant irregularities, often comprising streaks or spots of light particularly visible when located on the boundary between the grey area and the light area on said illuminated surface, on the projection of the light beam onto the illuminated surface.

This problem becomes even more apparent and urgent in case of lighting devices in which the orientation of the light sources is variable with respect to the axis of symmetry of the reflector. In these cases, it often occurs that the reflections of the light beam on the walls of the reflector itself cause the unevenness shown above as the inclination of the light sources increases towards the ends.

For example, FIG. 2 shows the case in which the orientation of said light sources is such that the main light emission direction is inclined with respect to the axis of rotation of the reflector, part of the reflected light beam, in particular the part related to the reflection on the upper part of the surface of the reflector—closest to the light sources—falls either on the limit or out of the main light cone 15 emitted by the lighting device, causing the streaks and spots of light 16 described above.

With reference the aforesaid technical problem, it is therefore an object of the present invention to introduce a new reflector for lighting devices, provided with appropriate means adapted to correct the lighting unevenness faults described above which tend to occur especially in lighting devices in which the orientation of the light sources is variable with respect to the axis of symmetry of the reflector.

### BRIEF DESCRIPTION OF THE FIGURES

FIG. 1a shows a perspective view of a preferred embodiment of the lighting device comprising the reflector according to the present invention.

FIG. 1b shows a section view of a preferred embodiment of the lighting device comprising the reflector according to the present invention.

FIG. 1c shows a perspective view of a preferred embodiment of the lighting device comprising the reflector according to the present invention.

FIG. 2 shows an example of the technical problems underlying the present invention, in the case of a lighting device in which the orientation of said light sources is such that the main direction of light emission is inclined with respect to the axis of rotation of the reflector and a reflected light beam which falls outside the main light cone is present.

### DISCLOSURE OF THE INVENTION

A reflector for flush installed lighting devices, adapted to eliminate possible undesired spots of light and unevenness of the produced light beam, said reflector being provided with a further reflective element, arranged on the surface of said reflector and essentially parallel to the lying plane of the greater opening of said reflector. Said further reflective element will preferably have a circular segment shape and dimensions which may vary according to the dimensions of said reflector and according to the inclination that the lighting assembly may assume with respect to the main body of the flush installed lighting device.

### DETAILED DESCRIPTION OF THE INVENTION

The appended figures show a typical embodiment of a lighting device for flush installation, comprises: a main body 10—comprising, in turn, fixing means to a wall 11, a frame 12 adapted to engage an opening in said wall and a reflector 13—and a lighting assembly 20, comprising, in turn, light sources 21 associated to possible thermal dissipation means 22, said lighting assembly 20 being associated to said main body 10 so that the mutual inclination thereof may be modified within two limit positions.

Said reflector 13 is of the rotationally symmetrical type—i.e. characterized by a rotational symmetry about an axis of rotation—and is provided with an apex comprising a first opening of such dimensions to enable the entrance of the luminous flux emitted by said light sources 21 and a second opening, of greater dimensions than the first opening, adapted to let out the direct light emitted by said light sources 21 and the light reflected by the inner surface of said reflector 13.

Said two openings lay approximately on planes which are inclined to each other by a certain angle α, the plane on which said second opening lies being essentially orthogonal to the axis of rotation of said reflector 13.

In this manner, said reflector 13 has a reflective internal surface which has a height varying between a minimum and a maximum at the distance between the lying planes of said first and second openings, and said light sources 21 face the part having greater height of the surface of said reflector 13 when said lighting assembly 20 is inclined with respect to said main body 10.

In the aforesaid inclination conditions of said lighting assembly 20 with respect to said main body 10, the reflections of part of the lighting beam emitted by said light sources 21 on a part of the surface of said reflector 13 may cause the unevenness illustrated above creating undesired light spots of various shape on the illuminated surface.

In order to avoid the aforesaid drawback and eliminate possible portions of the light emission 16 outside the main emission cone 15, said reflector 13 is provided with a further reflective element 14, arranged on said part having greater height of the surface of said reflector 13 and essentially parallel to the lying plane of said second opening.

Said further reflective element 14 will preferably be circular segment shaped, and have dimensions which may vary according to the dimensions of said reflector 13 and according to the inclination that said lighting assembly 20 may assume with respect to said main body 10, and will have the same surface finish of said reflector 13. Furthermore, said further reflective element 14 will be preferably positioned at a height which is closer to said first opening with respect to said second opening.

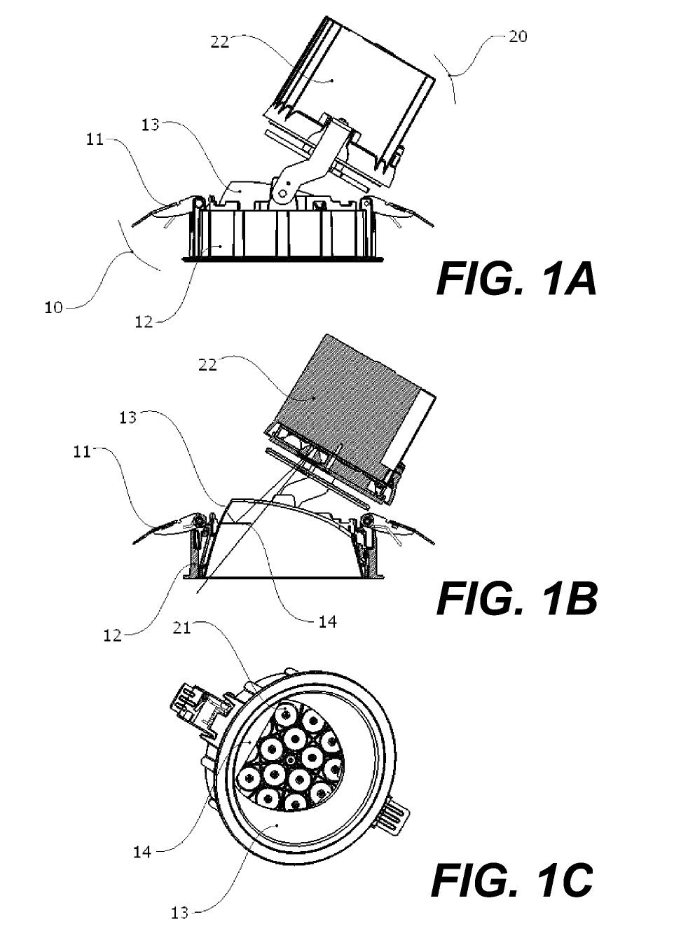

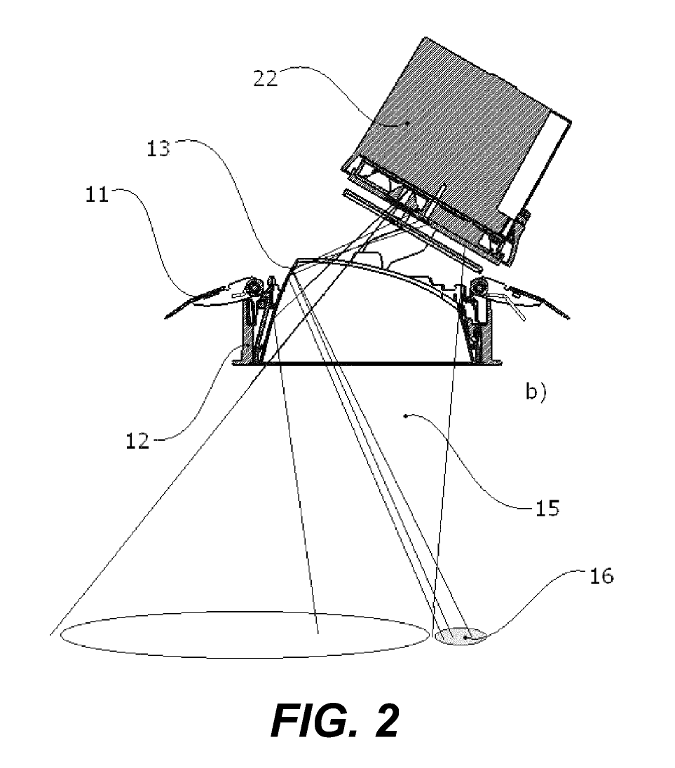

During the operation of the lighting device, said further reflective element 14 advantageously reflects a portion of the light flux emitted by said light sources 21—as shown in appended FIG. 1b)—so as to prevent said portion of light flux from being reflected outside the main lighting cone 15 causing undesired spots of light 16 and unevenness of the produced lighting.

1. A reflector of rotationally symmetrical type for lighting devices comprising:
a first opening of such dimensions to enable the entrance of the luminous flux emitted from the light sources of said lighting devices;
a second opening, of greater dimensions than the first opening, adapted to let out the direct light emitted by said light sources and that reflected by the internal surface of said reflector, said two openings approximately lying on planes which are inclined to each other by a certain angle α and the plane on which said second opening lies being substantially orthogonal to the axis of rotation of said reflector; and
a reflective internal surface which has a height varying between a minimum and a maximum in correspondence to the distance which runs between the planes on which said first and said second openings approximately lie, characterized in that it comprises a further reflective element, arranged on said part having a greater height of the surface of said reflector and substantially parallel to the lying plane of said second opening.

2. The reflector according to claim 1, wherein said further reflective element has a circular segment shape.

3. The reflector according to claim 1, wherein said further reflective element has the same surface finish as said reflector.

4. The reflector according to claim 1, wherein said further reflective element is positioned at a height which is nearer to said first opening with respect to said second opening.

5. A lighting device for flush installation comprising:
a main body comprising fixing means for fixing to a wall and a frame adapted to engage an opening in said wall; and
a lighting assembly comprising light sources, said lighting assembly being associated with said main body so that the mutual inclination thereof may be modified within two limit positions characterized in that said main body further comprises a reflector according to claim 1.

6. A lighting device for flush installation comprising:
a main body comprising fixing means for fixing to a wall and a frame adapted to engage an opening in said wall; and
a lighting assembly comprising light sources, said lighting assembly being associated with said main body so that the orientation of said light sources is such that the main direction of light emission is inclined with respect to the axis of rotation of the reflector, characterized in that said main body further comprises a reflector according to claim 1.

7. The lighting device according to claim 5, wherein said light sources are associated with possible thermal dissipation means.
